(19) United States
(12) Patent Application Publication
(10) Pub. No.: US 2002/0136797 A1
(43) Pub. Date: Sep. 26, 2002

(54) Method of making a microwaveable filled bagel dough product

(76) Inventor: Alvin Burger, Miami, FL (US)

Correspondence Address: Evelyn A. Defillo, Pendorf & Cutliff, P.O. Box 20445, Tampa, FL, 33622-0445, US

(21) Appl. No.: 09/813,544

(22) Filed: Mar. 21, 2001

(51) Int. Cl. A21D 10/00

(52) U.S. Cl. 426/19; 426/297; 426/496; 426/549

(57) ABSTRACT

A ready-to-eat filled bagel dough product can be produced by a method comprising preparing a bagel dough; sealing a quantity of filling material within a quantity of bagel dough to form a shaped, filled bagel dough product; adding topping to the shaped product; proofing the shaped product, and then (1) chilling or freezing the proofed, shaped product to reduce the filler core temperature, steaming the product for an amount of time sufficient to completely cook the dough, freezing the product for long term storage, and subsequently thawing and/or reheating in a microwave oven prior to consumption; or (2) chilling or freezing the proofed, shaped product to reduce the filler core temperature, steaming the product for an amount of time sufficient to completely cook the dough, again chilling the product to reduce the temperature of the filler, baking or browning the product, freezing the product for long term storage, and subsequently thawing and/or reheating in a microwave oven prior to consumption.

### FIELD OF THE INVENTION

The present invention relates to ready-to-eat filled bagel dough products, which can be thawed and/or heated in a microwave oven, while retaining their palatability, having a desirably fresh-tasting texture, and including a hard outer crust and a soft internal crumb. The invention also provides the method for preparing such products.

### DESCRIPTION OF THE RELATED ART

Bread products are an important food for proper nutrition. One popular bread product is known as a bagel.

Because the consumer demand for bagels over the years has increased dramatically, many companies are baking and freezing the bagels, then shipping them to smaller stores, grocery stores, delicatessens, etc.

While methods for preparing frozen bagels have been suggested in the past, prior art bagels obtained after freezing, storage, thawing, and baking have often not risen as much as desired and have had unduly thin and soft outer crusts.

Families, catering companies, restaurants, and fast food chains are requesting food products, which can be prepared with minimum preparation time, but at the same time, they want a high quality product, comparable to the standard food product. This desire has led to the widespread utilization of microwave ovens to heat food products. While microwave energy will rapidly heat most food products, not all microwave-heated products are able to deliver the same quality, as is characteristic of the more traditional conduction oven heated counterpart. This lack of quality is quite prevalent in the area of microwave reheated bagel products.

Problems have arisen with the use of microwave energy for reheating traditional yeast-raised bagel products. In particular, traditional bagel products become less palatable (the term palatable or palatability refers to the mouth feel and taste quality of food products) after short exposures to microwave energy. Bagel products, which have been exposed to microwave irradiation, have an increased toughness and a rubber or leather-like texture.

Microwave cooking is based on the ability of microwaves to interact with the components of a food product and generate heat energy. The amount of interaction and subsequent heat that is generated is related to the composition of the food and the specific heat of each ingredient. Food molecules, which carry a dipolar electrical charge, will vibrate as they align themselves with the rapidly fluctuating electric field. This causes heat or friction within the molecules. Since water carries a dipolar charge, foods containing high contents of water will generate a great deal of heat due to the reactiveness of water in a microwave.

In intermediate to low moisture foods such as bagels, dramatically different patterns of starch transformation can exist which normally are responsible for poor textures such as toughening and cracking. This is known as staling. The primary problem is that dehydration cannot occur at the surface since the water within the product is continually being converted to steam and migrating out, causing evaporative cooling and condensation at the surface. This provides a wet or soggy surface texture. Water boils at 100° C., and its heat exchange capability diminishes as it evaporates as steam.

When starch imbibes water during gelatinization, increased heating rates will occur in that location due to interaction of microwave radiation with water. Because more intense heat results from microwave energy, starch's tolerance to textural breakdown is narrowed.

A critical moisture level exists for most starches below which gelatinization will not take place. This is usually around 30%. Gelatinized or swollen starch binds less water to its structure; therefore, more water is free to respond to the alternating microwave field resulting in heat build up and undesirable moisture migration.

This creates serious consumer dissatisfaction because the bagel products are inedible by the time the consumer is prepared to consume them.

The addition of a moisture-containing filling arranged in or between a dough piece can further degrade the bagel dough product. While the freezing process per se can generally be affected without difficulty, moisture migration between dough and filling can still occur during frozen storage. Frozen storage, as typically conducted, results in the products going through a number of freeze/thaw cycles, during which the texture of both the filling and the dough will typically be degraded. Moreover, the reconstitution, or reheating, of the frozen product generally does not provide a product possessing the freshness and eating characteristics of the fresh, as-prepared product. During the reheating, moisture transfer from the filling to the dough portion often results in a product in which the dough is very soggy and lacks the crispness obtained in freshly prepared products.

Thus, there is a need in the art for a ready-to-eat product in which an edible, moisture-containing food filling is arranged in a bagel dough, which product is capable of being frozen and thawed and/or reheated in a microwave oven in a manner which results in a final product possessing textural, visual and organoleptic properties closely resembling those associated with the freshly prepared product prior to freezing and reheating.

### SUMMARY OF THE INVENTION

It is an object of the present invention to provide a filled bagel dough product, which can be stored for long periods of time in a freezer, and easily be reheated in a microwave oven without affecting its appearance or taste.

It is yet a further object of the invention to provide a process for preparing such a filled bagel dough product.

It is yet a further object of the invention to provide a filled bagel product, which is easy to handle and can be readily warmed and served in such environments as movie theaters, shopping malls, coffee shops, and food establishments.

It is an object of the present invention to provide a filled bagel dough product which has the outward appearance of a conventional bagel, which has the chewy bagel dough texture of a New York style bagel, and which is filled in the core with an even ring of meat, ham, hard cheese, bacon, sausage, seafood, poultry, egg, or a combination thereof.

In view of the foregoing disadvantages inherent in the prior art, the present inventor discovered a frozen filled bagel product that can be stored for a long period of time and thawed and/or reheated in a microwave oven maintaining a hard outer crust and soft inner crumb portion that provides a distinctive “bagel” taste and feel. In addition, the present invention created a method for preparing such a filled bagel product.

Despite the apparent technical contradictions of reheating a filled bagel product by using a microwave oven, the present inventor discovered that a microwaveable filled bagel dough product can be produced by a method comprising preparing a bagel dough; sealing a quantity of filling material within a quantity of bagel dough to form a shaped, filled bagel dough product; adding topping to the shaped product; proofing the shaped product, and then (1) chilling or freezing the proofed, shaped product to reduce the filler core temperature, steaming the product for an amount of time sufficient to completely cook the dough (1½ to 12 minutes), freezing the product for long term storage, and subsequently thawing and/or reheating in a microwave oven; or (2) chilling or freezing the proofed, shaped product to reduce the filler core temperature, steaming the product for an amount of time sufficient to completely cook the dough (1½ to 12 minutes), again chilling the product to reduce the temperature of the filler, baking or browning the product for 1½ to 5 minutes, freezing the product for long term storage, and subsequently thawing and/or reheating in a microwave oven.

Chilling the filling material prior to steaming will protect the filling material for a longer period of time as the product heats up from the outside in.

The step of steaming for 1½ to 12 minutes, depending upon the thickness of the dough around the filling material, forms a skin, not only on the outer surface of the dough, but also on the internal skin of the dough contacting the filling material, fully cooks the entire dough, sets the yeast, and forms a wet crust, producing a ready-to-eat product.

In the first embodiment of the present invention, the filled bagel dough product can be produced by a method comprising sealing a quantity of filling material within a quantity of bagel dough to form a shaped, filled bagel dough article, proofing the shaped product, chilling the proofed, shaped product to reduce the filler core temperature, steaming the chilled product between 1½ to 12 minutes, freezing the product for long term storage, shipping the filled bagel dough product, and reheating the filled product as desired by thawing the product and heating in a microwave oven.

In the second embodiment of the present invention, the filled bagel dough product can be produced by a method comprising sealing a quantity of filling material within a quantity of bagel dough to form a shaped, filled bagel dough article, proofing the shaped product, chilling the proofed, shaped product to reduce the filler core temperature, steaming the chilled product between 8-12 minutes, freezing the product for long term storage, shipping the filled bagel dough product, and thawing the product as desired.

The product is usually offered for sale, “ready to eat,” but may be sold in an unbaked or semi-baked state.

In the third embodiment of the present invention, the frozen filled product is baked prior to shipping.

In a fourth embodiment of the present invention, the steamed product is chilled after the steaming process.

The foregoing has outlined rather broadly the more pertinent and important features of the present invention in order that the detailed description of the invention that follows may be better understood, and so that the present contribution to the art can be more fully appreciated. Additional features of the invention will be described hereinafter, which form the subject of the claims of the invention. It should be appreciated by those skilled in the art that the conception and the specific embodiments disclosed may be readily utilized as a basis for modifying or designing other filled bagel products for carrying out the same purposes of the present invention. It should also be realized by those skilled in the art that such equivalent structures do not depart from the spirit and scope of the invention as set forth in the appended claims.

### DETAILED DESCRIPTION OF THE INVENTION

The present invention represents a significant advance over the technology disclosed in U.S. Pat. Nos. 5,641,527; 6,001,400; 5,654,021; 5,795,603; 5,514,395; and 5,236,724, each of which is incorporated herein by reference. After further experimentation, a process was surprisingly discovered which allows the filled bagel product to be thawed and/or heated in a microwave oven, retaining their palatability and having a desirably fresh-tasting texture including a hard outer crust and a soft internal crumb.

Bagel Fillings

The term filling is intended to refer to any product such as meat, seafood, poultry, ham, bacon, cream cheese, sausage, hard cheese, egg, or a combination thereof, which can be incorporated in a bagel dough and which gives off sufficient steam in the steaming or baking step of the processes discussed below for forming a skin on the interior surface of the filled bagel dough product.

Preparing Bagel Dough

Although the present invention is not limited to bagel dough, bagel dough is preferred, and the invention will be illustrated with examples using bagel dough. The term “bagel dough,” as used herein, refers to a very turgid, high protein dough, such as known to make bagels using conventional bagel-making techniques. Such dough is similar to a lean French bread dough, being firm to the touch and easily rolled upon a floured surface. The dough is comprised of a mixture of flour, water, yeast, salt, and, sometimes, sugar. The flour should be a high gluten flour, such as a good clear spring wheat flour with protein content of typically 13.5-14% of flour weight. Water should be added in a quantity of typically 50-53% of flour weight. Salt content should typically be 1.5-2.2% of flour weight. Yeast should be added in a quantity of typically 0.5-2% of flour weight. Sugar, which serves as a food for the yeast and not as a contributor to the final product, should be a dextrose, corn syrup, high fructose or other fermentable sugar, and can be added up to 4% of flour weight. Residual sugar contributes to the browning of the crust during baking.

Although it is possible to obtain and mix all the separate individual ingredients necessary for making a bagel dough, it has been found more convenient to form the bagel dough using a powdered base such as that produced by PURATOS COMPANY. In a specific example, 5 lbs. of base are mixed with 50 lbs. of water at 50-55° F. If the water is too hot, the yeast may subsequently be too active and overdevelop, thus the initial water temperature should not exceed 55° F. To this base and water are added 14 oz. of yeast, 100 lbs. of high gluten flour, and optionally improvers and flavors. The preferred flour is high in ash and protein and gives the bagel product the distinctive chewy texture. The ingredients are mixed for 10-12 minutes during which time the dough rises in temperature to 75-78° F. The dough is then allowed to proof or develop for a period until it becomes stretchable and workable.

Shaping Bagel Dough

Next, the bagel dough, preferably relaxed bagel dough, is formed into a continuous flat sheet of dough approximately 2-4 inches wide, preferably 3¾ inches wide. The sheet of dough may be formed by hand, and the entire filling and process may be performed by hand, but for manufacturing on a large scale, it is preferred to manufacture by an automated procedure using conventionally available equipment or slightly modified conventionally available equipment.

The process for shaping the shaped bagel products, according to the invention, may be as varied as the products themselves. The products may be in any of a variety of shapes and sizes. The product may be elongated, circular, torroid, diamond shaped, hexagonal, or even in the shape of a pretzel.

In the case of forming the torroidal bagel product, the filled shape can be produced by any suitable technique such as co-extrusion, forming by hand, wrapping, forming a ball and either manually or mechanically transforming the filled ball into a filled torroid, or by laminating an upper hemispherical bagel shell to a filled lower hemispherical bagel shell.

In the case of forming a platelet shaped product, the filled shape can be produced by any suitable technique such as forming a filled ball or other shape and compressing the shape, preferably to a greater extent centrally than peripherally, to form a platelet, or by a laminating process wherein the filling material is deposited onto a lower bagel dough shell layer, superposing an upper bagel dough shell layer over the lower layer, and laminating the upper and lower bagel shell layers to hermetically seal the filling material cream cheese between the upper and lower layers, and if necessary, cutting or trimming the filled product to any desired pattern or shape.

Various ways of automatically filling a dough shell prior to cooking or baking are known. In a typical procedure, as exemplified by U.S. Pat. Nos. 4,334,464, 4,446,160 and 4,515,819 to Shinriki, a ball-shaped encrusted bakery product is automatically formed by depositing a ball of sticky edible paste material (e.g. jam) onto a starch film. Thereafter, a dough sheet is gathered around the ball to enclose it with dough before cooking. In U.S. Pat. No. 4,882,185 to Hayashi, a vertical tubular extrusion of bread dough crust material and jam or cream core material is cut and formed into two-layered balls without exposure of the core material. Other methods of production of filled dough products are described in U.S. Pat. Nos. 4,794,009 and 4,882,185.

The shell may also be filled using a co-extrusion process, as well known in the bakery product art. For example, U.S. Pat. No. 4,251,201 to Krysiak illustrates an apparatus for the preparation of a filled pretzel. Such filled shapes are also within the contemplation of the invention.

Any conventional shaping process can be used for this step.

Toppings

At any time prior to proofing, toppings such as cheese, tomatoes, ham, garlic, spinach, etc. may be applied to the top of the bagel dough product, particularly the platelet shaped product. Topping prior to proofing results in the topping being more firmly adhered to the bagel product, which facilitates handling, transporting, packaging, and consumption.

Proofing

The filled bagel product is then placed to proof within a warm cabinet (proofer) or unheated oven for 20-90 minutes, preferably 45-60 minutes at approximately 80°-120° F., preferably 90°-110° F., which permits the yeast to raise the dough.

Chilling or Freezing

Subsequent to proofing, the product should be chilled or frozen before steaming. Chilling or freezing provides the filling material with a cool internal temperature, which protects the filling material during steaming.

The product is chilled or frozen until the filling material is about 0 to 32° F., preferably 0° F. This step prevents moisture migration between dough and filling during the steaming process, thus, preserving texture and taste.

Steaming

The filled, shaped, proofed, and chilled or frozen bagel dough product may be steamed to fully cook the dough, approximately 1½ to 12 minutes, preferable 5 to 12 minutes, more preferably 8 to 12 minutes. The steaming time will depend on the thickness of the dough around the filling material.

During steaming, the filling material has a higher ability to withstand heat, a slower rate of heat absorption, and is partially blanketed by dough, and thus remains cooler than the dough. During steaming, dough may rise to a temperature of 200-240° F., while the filling material in the dough only rises to a temperature of 140-180° F.

The product of the invention can be placed in a steamer for a time sufficient to enable the hot steam to form a skin, not only on the outer surface of the dough, but also on the internal skin of the dough, contacting the filling material, fully cook the entire dough between the outer surface and the internal skin of the dough, setting the yeast, and forming a wet crust.

A fully cooked product shows the same texture along the outer surface and the internal skin of the dough. Surprisingly, the product of the present invention can be sold as a ready-to-eat product, which can be thawed and/or reheated in a microwave oven without losing its freshness.

The moisture is removed from the surface of the product by using a fan.

Egg Wash

The filled bagel product may be glazed with egg wash prior to the baking step and may be filled, topped, or coated with other assorted seasonings and spices, such as sesame seeds, poppy seeds, salt, pepper, Cajun spices, liquid smoke impregnated, marinated vegetable bits, dried onion, dry cheese, spicy corn meal, etc., to enhance the flavor and to accommodate the tastes and specific desires of individual consumers, or may be wet with water or egg white and water, then rolled in seeds, etc., to completely coat the exterior of the finished product.

The present process produces a filled bagel dough product, which is different from other frozen bagel dough products. Due to the combination of the chilling step, followed by the long steaming time, the bagel is completely cooked after steaming and can be packaged unbaked.

Chilling or Freezing—Optional

Chilling or freezing the product after the outside has been set by steaming is necessary to cool the filling material enough to prevent moisture migration between dough and filling.

The filled bagel product is chilled or frozen until the filling material is about 0°-40° F.

Browning—Optional

The steamed and then chilled or frozen product may next be placed in an oven at 70° F. or less, for approximately 1 to 10 minutes, preferably about 1½ to 3 minutes, to brown the exterior crust. The time the product is placed in the oven depends upon the temperature and type of oven, and size of the filled product.

Because the product is already completely cooked, the browning time can be significantly reduced.

The yeast is most likely fully deactivated prior to the browning step, but any remaining active yeast may continue to ferment within the crumb for a short period to reduce the size of gas cells in the annular interior of the baked product. The finished dough texture becomes compacted, since the crusts have already been set during the steaming step.

Freezing

The product may be frozen at any time after proofing and steaming, and the product may be stored in a freezer for up to one year without deterioration.

Packaging

Any conventional packaging process may be used.

Reconstitution

The resulting product is a ready-to-eat filled bagel dough product, which can be defrosted (2-4 hours) or reheated in a microwave oven to provide enjoyment of the distinctive bagel taste. The process of the invention enables the steamed product to be frozen, including the filling material, for extended periods with no deterioration in quality.

The proofed, steamed ready-to-eat product is sold to consumers in a frozen state, and may be thawed and/or microwaved by the consumer prior to consumption. The heat in the microwave oven penetrates in the center of the filling material and does not damage the dough, thus the filled bagel dough product of the invention displays unique characteristics that are not predictable from other reheated frozen bagel dough products. Thus, confirming that the method of making microwaveable filled bagels according to the present invention is not comparable to other frozen bagel dough processes. The process provides a novel filled bagel product that provides both bagel and special flavor in a conveniently packaged, prepared combination.

Further, the product may even be reheated in a toaster oven or in a wide slot pop-up toaster to develop a crispy crust.

### COMPARATIVE EXAMPLE

A bagel dough product was prepared according to the boiling then baking preparing process, by using a recipe containing usual ingredients such as flour, water, yeast, salt, and, sometimes, sugar. A bagel product is also prepared according to the process of the present invention.

Comparative baking tests were carried out between the regular bagel dough product and the filled bagel dough product of the present invention.

When the products were re-heated in a microwave oven, the boiling then baking bagel product presents an increased toughness and a rubber or leather-like texture, while the filled bagel dough product of the present invention presents a fresh-tasting texture, including a hard outer crust and a soft internal crumb.

Although this invention has been described in its preferred form with a certain of particularity with respect to a microwaveable filled bagel dough product, it is understood that the present disclosure of the preferred form has been made only by way of example, and that numerous changes in the details of structures and the composition of the combination may be resorted to without departing from the spirit and scope of the invention.

Now that the invention has been described,

I claim:

1. A process for making a ready-to-eat filled bagel dough product, comprising the steps of:
(a) mixing and kneading flour, water, salt and yeast to form a bagel dough;
(b) measuring an amount of a filler material;
(c) enclosing said amount of filler material within bagel dough produced in step (a) to produce a filled bagel dough product;
(d) proofing the filled bagel dough product to activate said yeast to raise said bagel dough through fermentation;
(e) chilling or freezing the product of step (d); and
(f) steaming the product of step (e) to fully cook the dough.

2. A process as in claim 1, further including:
(g) optionally chilling or freezing the product of step (f);
(h) freezing the product of step (g); and
(i) packing the product;
wherein the product of step (i) is thawed and optionally heated in a microwave oven by the consumer prior to consumption.

3. A process as in claim 1, wherein the shape of the filled bagel is selected from the group consisting of platelet, log, circular, torroid, diamond, hexagonal, and pretzel.

4. A process as in claim 1, further including adding toppings to the product prior to proofing.

5. A process as in claim 1, wherein the steaming time is between 1½ to 12 minutes.

6. A process as in claim 1, wherein said filler is selected from the group consisting of cheese, meat, seafood, poultry, ham, bacon, cream cheese, sausage, hard cheese, egg, and combination thereof.

7. A process as in claim 1, wherein said dough is comprised of flour having a protein content of 13.5-14% of flour weight, a water content of 50-53%, a salt content of 1.5-2.2% of flour weight, and a yeast content of 0.5-2% of flour weight.

8 A process for making a ready-to-eat filled bagel dough product, comprising the steps of:
(a) mixing and kneading flour, water, salt and yeast to form a bagel dough;
(b) measuring an amount of a filler material;
(c) enclosing said amount of filler material within bagel dough produced in step (a) to produce a filed bagel dough product;
(d) proofing the product of step (c) to activate said yeast to raise said bagel dough through fermentation;
(e) chilling or freezing the product of step (d);
(f) steaming the product of step (e) to fully cook the dough;
(g) chilling or freezing the product of step (f);
(h) baking the product of step (g) for approximately 1-10 minutes for browning the product.

9. A process as in claim 8, further including:
(i) freezing the product of step (h); and
(j) packing the product;
wherein the product of step (j) is thawed and optionally heated in a microwave oven by the consumer prior to consumption.

10. A process as in claim 8, wherein the shape of the filled bagel is selected from the group consisting of platelet, log, circular, torroid, diamond, hexagonal, and pretzel.

11. A process as in claim 8, further including adding toppings to the product prior to proofing.

12. A process as in claim 8, wherein the steaming time is between 1½ to 12 minutes.

13. A process as in claim 8, wherein said filler is selected from the group consisting of cheese, meat, seafood, poultry, ham, bacon, cream cheese, sausage, hard cheese, egg, and combination thereof.

14. A process as in claim 8, wherein said dough is comprised of flour having a protein content of 13.5-14% of flour weight, a water content of 50-53%, a salt content of 1.5-2.2% of flour weight, and a yeast content of 0.5-2% of flour weight.

15. A process as in claim 1, wherein the product is chilled or frozen to a core temperature of 0 to 40° F.

16. A process for making a ready-to-eat filled bagel dough product, comprising the steps of:
(a) mixing and kneading flour, water, salt and yeast to form a bagel dough;
(b) measuring an amount of a filler material;
(c) enclosing said amount of filler material within bagel dough produced in step (a)to produce a filled bagel dough product;
(d) proofing the product of step (c)to activate said yeast to raise said bagel dough through fermentation;
(g) chilling or freezing the product of step (d);
(h) steaming the product of step (g) to fully cook the dough;
(i) optionally chilling or freezing the product of step (h);
(j) freezing the product of step (i); and
(k) packing the product; and
(l) heating the product in a microwave oven prior to consumption;
wherein the filled bagel dough product has a fresh taste.
